(19) United States
(12) Patent Application Publication
(10) Pub. No.: US 2026/0102040 A1
(43) Pub. Date: Apr. 16, 2026

(54) SYSTEMS AND METHODS FOR DISHMACHINE AUTOMATIC PRESCRAPPING

(71) Applicant: Ecolab USA Inc., Saint Paul, MN (US)

(72) Inventors: Michael Richard Ney, Minneapolis, MN (US); Matthew R. Peltier, Cooage Grove, MN (US); John Ralph Mansergh, Cottage Grove, MN (US); Andrew Michael Jensen, St. Paul, MN (US)

(21) Appl. No.: 19/359,153

(22) Filed: Oct. 15, 2025

Related U.S. Application Data
(60) Provisional application No. 63/708,189, filed on Oct. 16, 2024.

(51) Int. Cl. A47L 15/00; A47L 15/42; C02F 1/00; G05B 13/02

(52) U.S. Cl. CPC A47L 15/0005; A47L 15/0026; A47L 15/0063; A47L 15/0081; A47L 15/4202; A47L 15/4219; A47L 15/4225; C02F 1/003; G05B 13/0265; A47L 2401/04; A47L 2501/28; C02F 2307/12

(57) ABSTRACT

Various examples are directed to systems and methods for dishwasher automatic prescrapping. A method includes monitoring a dishwasher to sense placement of dishware within the dishwasher. Upon sensing placement of the dishware, the method includes circulating, using wash arms of the dishwasher, wash water over the dishware. Using a collection tray, the wash water and soil are collected from the dishware. The collection tray includes a slope configured to direct the wash water and the soil to an external separator. The method further includes automatically separating, within the external separator, the soil from the wash water. The external separator provides removal access of the separated soil. The method also includes directing, by the external separator, the separated wash water to a wash sump tank for recirculation in the dishwasher for subsequent wash cycles.

### CLAIM OF PRIORITY AND INCORPORATION BY REFERENCE

The present application claims the benefit under 35 U.S.C. § 119(e) of U.S. Provisional Patent Application 63/708,189, filed Oct. 16, 2024, the disclosure of which is hereby incorporated by reference herein in its entirety.

### TECHNICAL FIELD

This application relates generally to washing machines and more particularly to systems and methods for automatic prescrapping in a washing machine such as a dishwasher.

### BACKGROUND

A dishwasher, also referred to as a dishmachine, warewasher or warewashing machine, is a machine for automatically cleaning articles, such as dishes, trays, laboratory equipment, dinnerware, and kitchenware. A common domestic dishwasher is an undercounter unit intended to be installed under a kitchen counter. Other types of dishwashers include industrial or commercial dishwashers for use in restaurants, hotels, and other commercial establishments with food services.

Common commercial dishwashers require dishware to be manually prescrapped, by scrubbing or spraying the dishware to remove soil or debris, prior to placing the dishware in the machine. This process is time consuming and increases labor costs for a business that uses the dishwasher. If the dishware is not manually prescrapped, the soil on such dishware, such as bulk foods, may interfere with dishwasher operation and require the machine to be dumped and refilled before resuming a wash cycle. Large amounts of soil may also block wash arms and cause damage to dishwasher components, resulting in dishwasher down time and incurring costs involved with servicing the machine and replacing the components.

What is needed is an improved prescrapping system for dishwashers that provides for shorter machine down times and more efficient machine operation.

### SUMMARY

A system and method for automatic prescrapping for dishwashers is provided. A method includes monitoring a dishwasher to sense placement of dishware within the dishwasher. Upon sensing placement of the dishware (and in some cases before starting a wash cycle of the dishwasher), the method includes circulating, using wash arms of the dishwasher, wash water over the dishware. Using a collection tray, the wash water and soil are collected from the dishware. The collection tray includes a slope configured to direct the wash water and the soil to an external separator. The method further includes automatically separating, within the external separator, the soil from the wash water. The external separator provides removal access of the separated soil. The method also includes directing, by the external separator, the separated wash water to a wash sump tank for recirculation in the dishwasher for subsequent wash cycles.

Various examples, include a system for automatic prescrapping for dishwashers. The system includes one or more sensors configured to monitor a dishwasher to sense placement of dishware within the dishwasher. The system also includes one or more processors configured to receive a signal from the one or more sensors, and to initiate circulation of wash water over the dishware based on the signal. The system further includes a collection tray configured to collect the wash water and soil from the dishware, and a separator configured to separate the soil from the wash water and provide removal access to the separated soil The collection tray includes a slope configured to direct the wash water and the soil to the separator. The separator is external to the dishwasher and is configured to direct the separated wash water to a wash sump tank for recirculation into the dishwasher for subsequent wash cycles.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

1The drawings illustrate generally, by way of example, various embodiments discussed in the present document. The drawings are for illustrative purposes only and may not be to scale.

FIGS. 1A-1D illustrate perspective views of a system for automatic prescrapping for a dishwasher, according to various embodiments.

FIGS. 1E-1G illustrate perspective views of a dishwasher, according to various embodiments.

FIG. 2A illustrates a block diagram of a system for automatic prescrapping for a dishwasher, according to various embodiments.

FIGS. 2B-2D illustrate example graphical displays for a mobile application of the present system for a dishwasher, according to various embodiments.

FIG. 3 illustrates an example machine learning module for automatic prescrapping for a dishwasher, according to various embodiments;

FIG. 4 illustrates a flowchart of a method for automatic prescrapping for a dishwasher, according to various embodiments.

FIG. 5 is a block diagram of a machine in the example form of a computer system within which a set of instructions may be executed, for causing the machine to perform any one or more of the methodologies discussed herein.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The scope of the present invention is defined by the appended claims, along with the full scope of legal equivalents to which such claims are entitled.

Common commercial dishwashers require dishware to be manually prescrapped, by scrubbing or spraying the dishware to remove soil or debris, prior to placing the dishware in the machine. This process is time consuming and increases labor costs for a business that uses the dishwasher. If the dishware is not manually prescrapped, the soil on such dishware, such as bulk foods, may interfere with dishwasher operation and require the machine to be dumped and refilled before resuming a wash cycle. Large amounts of soil may also block wash arms and cause damage to dishwasher components, resulting in dishwasher down time and incurring costs involved with servicing the machine and replacing the components.

The present subject matter provides an improved prescrapping system for dishwashers that provides for shorter machine down times and more efficient machine operation. The system leverages machine learning to monitor the dishwasher and to determine when to initiate circulation of the wash water over dishware in the dishwasher, providing for automatic prescrapping for the dishwasher.

In various examples, the present subject matter provides for automatic prescrapping and removal of bulk food soils for machine warewashing applications. The present system reduces customer labor costs and improve operation of the machine, by incorporating removal of bulk food soils from dishware directly into the dish machine, eliminating the need for dish operators to have to prescrap (scrub and/or pre-spray) prior to putting ware in the machine. According to various embodiments, the present system provides a passive or active method for mechanically separating food soils and debris from the wash tank water of a commercial dish machine. In some examples, the separation is performed externally to the machine allowing for easy disposal, either through a manual or automated process, of the scrap debris. The present system maintains clean wash water, eliminates the need to frequently dump and refill the machine, and eliminates the need to prescrap ware prior to putting in the machine. The present system may be used anywhere bulk debris or soils needs to be removed from a separate sump. In some examples, the present system may also be used to remove finer debris with adjusted filter and strainer sizing.

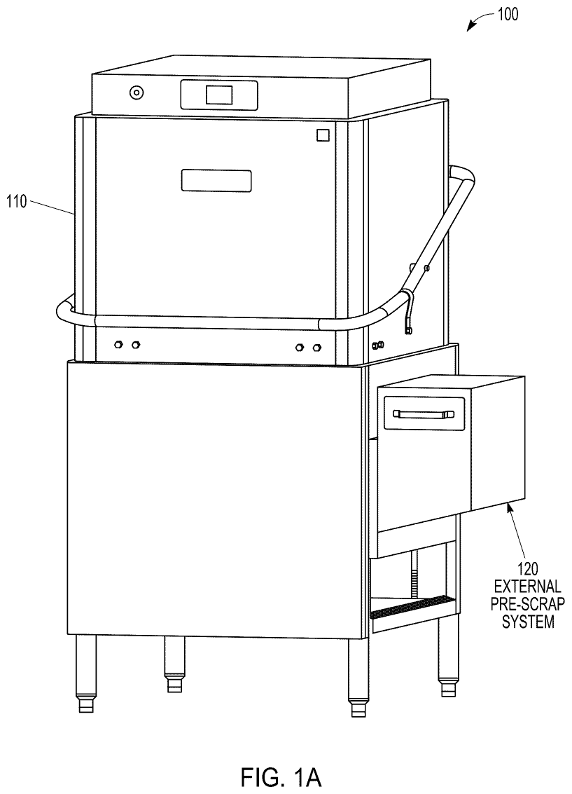

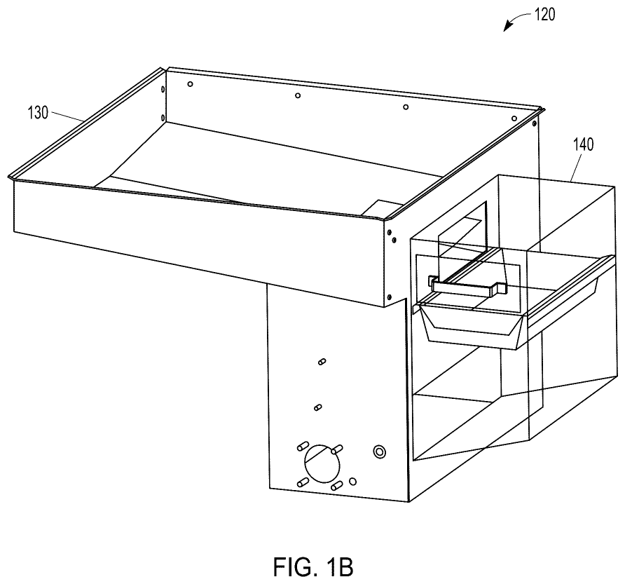

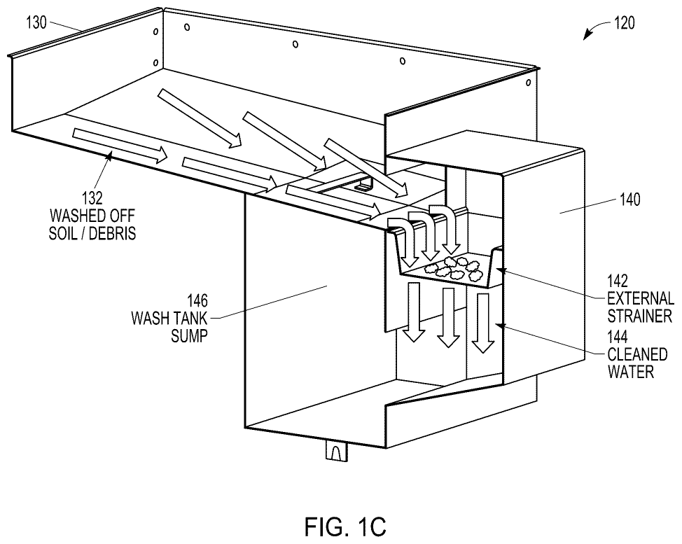

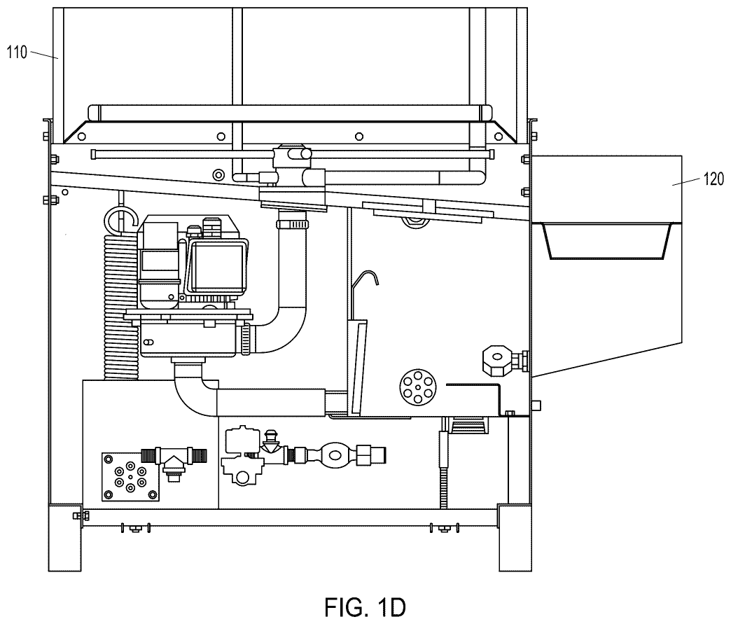

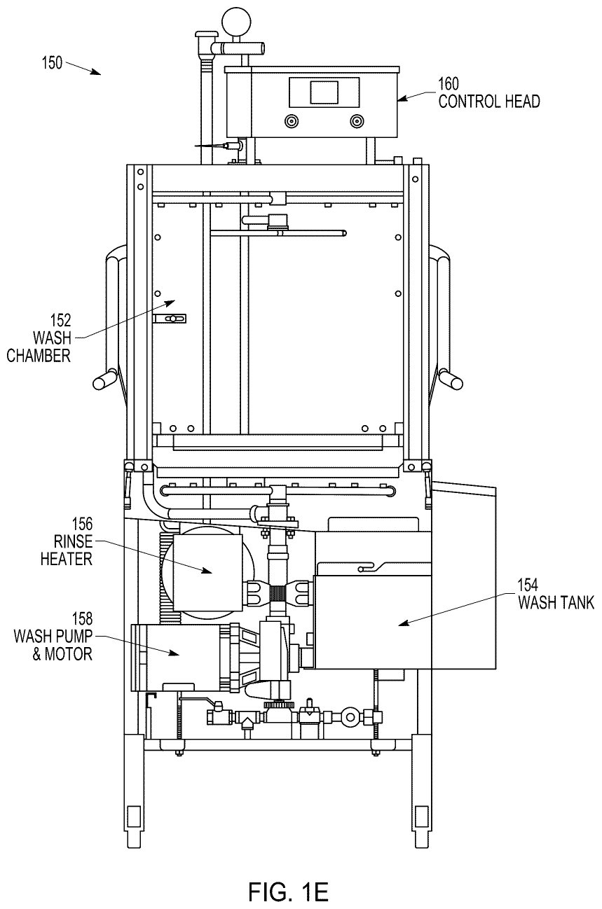

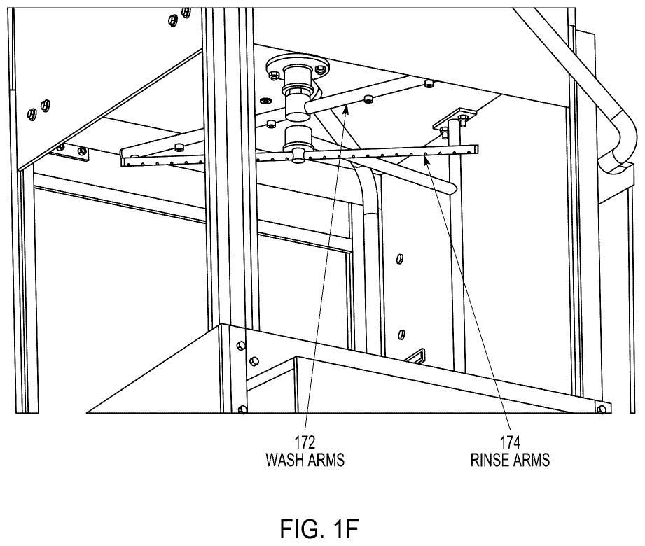

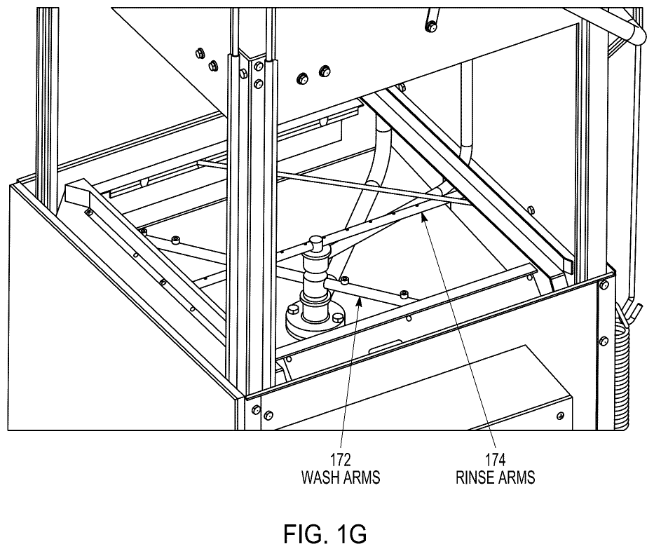

FIGS. 1A-1D illustrate perspective views of a system for automatic prescrapping for a dishwasher, according to various embodiments. As shown in FIG. 1A, the system 100 includes a dishwasher 110 and a pre-scrap system 120 attached to or incorporated with the dishwasher 110, in various embodiments. The system 100 includes a strainer that is accessible to the user without the need to access the inside of the dishwasher 110, in various examples. The pre-scrap system 120 may include a collection tray 130 within the dishwasher 110 configured to collect the wash water and soil from the dishware, and a separator 140 within an external portion of the pre-scrap system 120 (external to the dishwasher 110) configured to separate the soil from the wash water and provide removal access to the separated soil, as shown in FIG. 1B. The collection tray 130 includes a slope 132 configured to direct the wash water and the soil to the separator 140, as shown in FIG. 1C. In some examples, the separator 140 includes a strainer 142 or other separation device to separate the soil from the wash water. The separator 140 is external to the dishwasher and is configured to direct the separated wash water 144 to a wash sump tank 146 for recirculation into the dishwasher for subsequent wash cycles, in various embodiments.

FIG. 1C shows the flow through the system, in various embodiments. As wash water is recirculated over the ware from the machines wash arms, the washed off soil and debris travels down the compound slope to be directed into the external prescrap system. In some examples, a mechanical strainer separates the bulk food soil and debris from the wash water. The strained wash water then enters back into the wash tank sump where it is available to the wash pump for further recirculation. The collected debris can be manual discarded by the user or through an automated process. FIG. 1D shows a rear view of the dishwasher 110 and pre-scrap system 120, in some examples.

FIGS. 1E-1G illustrate perspective views of a dishwasher, according to various embodiments. FIG. 1E shows a dishmachine or dishwasher 150 having a wash changer 152, a wash tank 154, a wash pump and motor 158, and a rinse heater 156. In various embodiments, a control head 160 is affixed to or placed on top of the dishwasher 150 and used to control operation of the dishwasher 160. FIG. 1F shows a view of the dishwasher 150 showing upper wash arms 172 and rinse arms 174 used for circulating water to clean dishes in the dishwasher. FIG. 1G shows a view of the dishwasher 150 showing lower wash arms 172 and rinse arms 174.

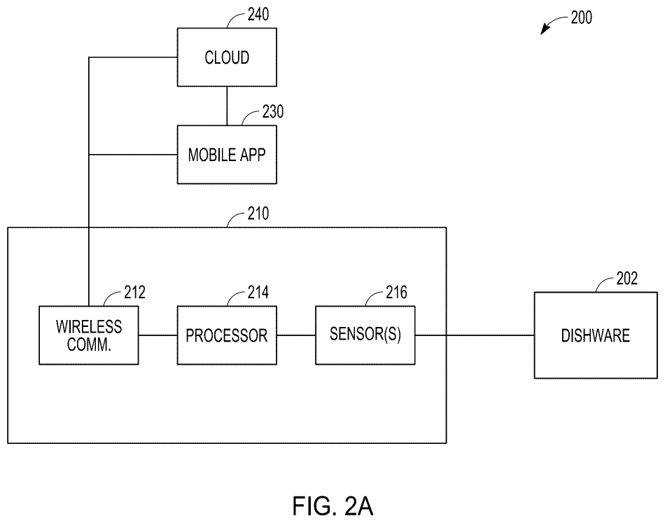

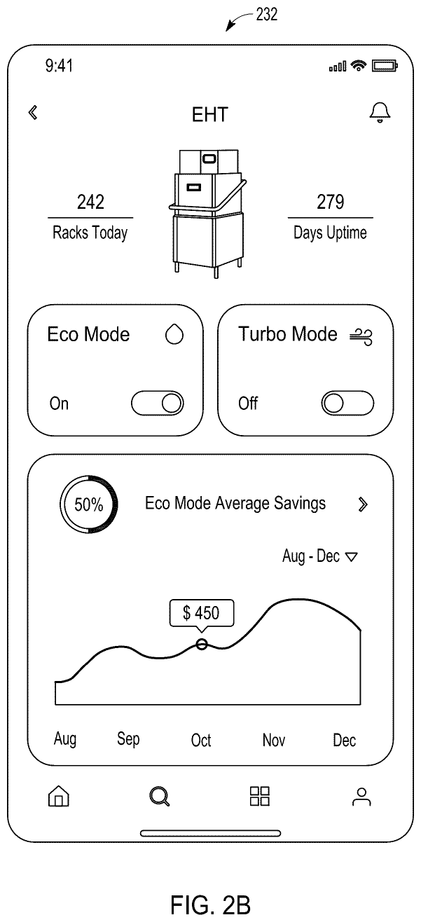

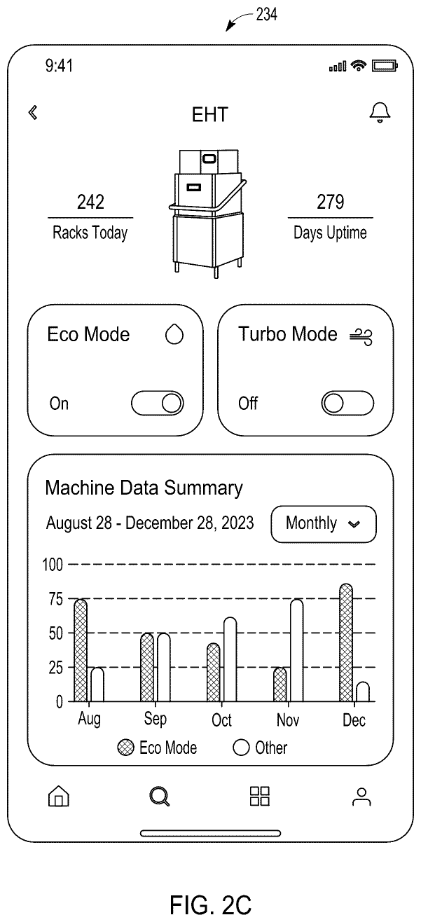

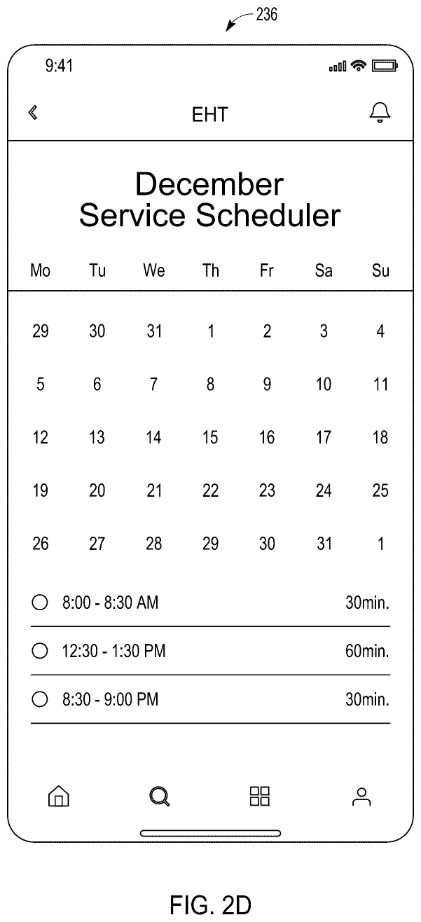

FIG. 2A illustrates a block diagram of a system for automatic prescrapping for a dishwasher, according to various embodiments. The system 200 includes an electronic control board 210 including one or more sensors 216 configured to monitor a dishwasher during operation of the dishwasher, a microprocessor 214 (or microcontroller or the like) configured to detect conditions of the dishwasher using signals from one or more sensors, and a wireless communication transceiver 212 configured to transmit information regarding dishwasher operation, such as prescrapping for a dishwasher. The sensors 216 may be configured to monitor the dishwasher to sense placement of dishware 202 within the dishwasher, and to sense a soil level of the dishware 202, in various examples. The system 200 also includes one or more processors 214 and a data storage system in communication with the one or more processors.

The data storage system comprises instructions thereon that, when executed by the one or more processors, causes the one or more processors to receive a signal from the one or more sensors 216, and further configured to initiate circulation of wash water over the dishware 202 based on the signal. The processor 214 may communicate with a cloud system 240 and/or a mobile device 230, such as a phone, tablet, or other computing device using the wireless communication transceiver 212, in various embodiments.

In various embodiments, the instructions further cause the one or more processors 214 to log the operation details of the dishwasher in a memory. According to various embodiments, the one or more processors may include the microprocessor 214 of the electronic control board 210, a processor of a mobile device 230, and/or a processor of a cloud-based system 240. The wireless communication transceiver may include a Bluetooth communication transceiver or a cellular communication transceiver, in some examples. The one or more sensors are configured to monitor soil level of dishware placed in the dishwasher, in one embodiment.

Other signals, such as temperature, acoustics, vibration, and the like, may be monitored without departing from the scope of the present subject matter. According to various embodiments, the one or more sensors may include the embedded sensor or sensors of the control board 210, a sensor or sensors on or in the dishwasher, and/or a sensor or sensors remote from the dishwasher and remote from the control board. In some embodiments, displaying information about operation of the dishwasher includes using a mobile application configured to execute on a user mobile device 230. In some embodiments, the information may be displayed on a display on the dishwasher. Other data sources and modes of communicating the information are possible without departing from the scope of the present subject matter. Different sources and modes of communicating information may be used in combination in various embodiments.

The control board 210 may use edge computing at a local controller to analyze the data. A processor 214 may be used on the device to analyze data from the sensor 216 and determine when to initiate circulation of the wash water over the dishware (e.g., using edge computing and/or machine learning), or the raw data may be sent to an external device or to the cloud for remote analysis. Data may be sent either locally (e.g., using Bluetooth, ZigBee, Wi-Fi, LoRa, etc.), or to a central cellular gateway for further analysis. A number of wireless protocols may be used by the present device to communicate and report dishwasher monitoring results or other data to one or more external devices (such as a computer, a smartphone, a tablet, etc.), to other devices, to a router, to a gateway, or the like. The wireless standards that may be used by the present subject matter include, but are not limited to, one or more of the following: LoRa, near-field communication (NFC), Bluetooth, Bluetooth Low Energy (BLE), Ethernet, Wi-Fi, WiMax, ZigBee, or cellular standard communications such as 3G, 4G, LTE, 5G. Other wireless standards may be used without departing from the scope of the present subject matter.

The system 200 may further include a display element such as a light emitting diode (LED) on a surface of the housing, or other type of display for providing device status or the like. In various examples, the control board 210 may also include wireless communication electronics 212 connected to the controller and configured to provide for wireless communications with one or more external devices. The control board may be used with a mobile application that receives information from the control board and provides information to the user or service associate.

FIGS. 2B-2D show screenshots of a customer application for a customer having the dishwasher, providing savings template 232 for various machine modes in FIG. 2B, a machine data summary 234 for use of the dishwasher in FIG. 2C, and a service schedule calendar 236 for planning service of the dishwasher based on the diagnostics in FIG. 2D. The customer application provides data reporting from the dishwasher and provides customers with operational modes that the customer may activate, such as a ‘turbo mode’ that increases chemical products and runs faster cycles to help a customer get through a rush period while not increasing their chemical use. Another mode available on the customer application is an ‘energy saving’ mode that turns off heaters whenever the machine is idle for a programmable time period (15 minutes in one example). Yet another mode available on the customer application is a ‘ware specific’ mode for washing certain items. An additional mode available on the customer application is ‘prescrapping’ mode, which may activate the mode or enable automatic activation of the mode, in various examples. Other modes may be available on the customer application without departing from the scope of the present subject matter. In addition, the modes may be automatically activated and programmable from the customer application. For example, the customer may schedule the turbo mode from between 10 am to 2 pm. In various examples, the mobile application provides the user with a diagnostic of the dishwasher, provides a part list and step-by-step instructions (textual or visual or both), provides confirmation that the repair was successful, and places components in a shopping cart for ease of reordering. Various examples of the mobile application include a status dashboard, a diagnostic summary, a self-diagnosis list, visual instructions, and confirmation of results.

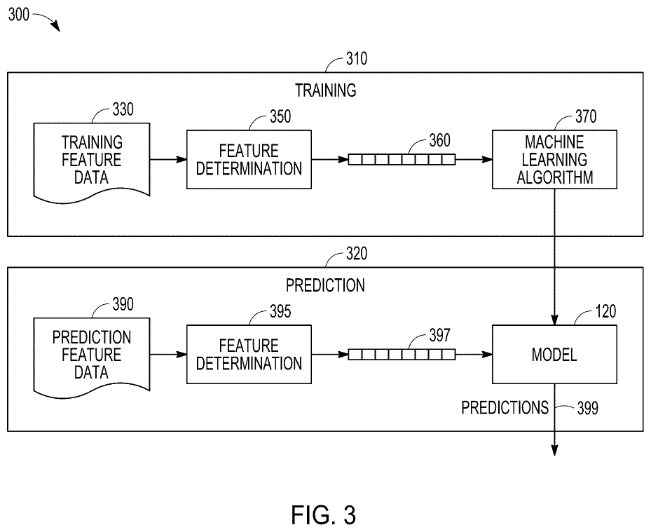

FIG. 3 shows an example machine learning module 300 according to some examples of the present disclosure. The machine learning module 300 may be implemented in whole or in part by one or more computing devices. In some examples, the training module 310 may be implemented by a different device than the prediction module 320. In these examples, the model 120 may be created on a first machine and then sent to a second machine.

Machine learning module 300 utilizes a training module 310 and a prediction module 320. Training module 310 inputs training feature data 330 into feature determination module 350. The training feature data 330 may include data determined to be predictive of monitoring a dishwasher and determining when to initiate automatic prescrapping for the dishwasher.

Categories of training feature data may include tracked data, input data, image data, user data, other third-party data, or the like. Specific training feature data and prediction feature data 390 may include, for example one or more of: current tracked data, past tracked data, and the like.

Feature determination module 350 selects training vector 360 from the training feature data 330. The selected data may fill training vector 360 and comprises a set of the training feature data that is determined to be predictive of determining when to initiate automatic prescrapping for a dishwasher. In some examples, the tasks performed by the feature determination module 350 may be performed by the machine learning algorithm 370 as part of the learning process. Feature determination module 350 may remove one or more features that are not predictive of determining when to initiate automatic prescrapping for a dishwasher to train the model 120. This may produce a more accurate model that may converge faster.

Information chosen for inclusion in the training vector 360 may be all the training feature data 330 or in some examples, may be a subset of all the training feature data 330.

In other examples, the feature determination module 350 may perform one or more data standardization, cleanup, or other tasks such as encoding non numerical features. For example, for categorical feature data, the feature determination module 350 may convert these features to numbers. In some examples, encodings such as “One Hot Encoding” may be used to convert the categorical feature data to numbers. This enables a representation of the categorical variables as binary vectors and provided a “probability-like” number for each label value to give the model more expressive power. One hot encoding represents a category as a vector whereby each possible category value is represented by one element in the vector. When the data is equal to that category value, the value of the vector is a ‘1’ and all other elements are zero (or vice versa).

The training vector 360 may be utilized (along with any applicable labels) by the machine learning algorithm 370 to produce a model 120. In some examples, other data structures other than vectors may be used. The machine learning algorithm 370 may learn one or more layers of a model. Example layers may include convolutional layers, dropout layers, pooling/up sampling layers, SoftMax layers, and the like. Example models may be a neural network, where each layer is comprised of a plurality of neurons that take a plurality of inputs, weight the inputs, input the weighted inputs into an activation function to produce an output which may then be sent to another layer. Example activation functions may include a Rectified Linear Unit (ReLu), and the like. Layers of the model may be fully or partially connected. In other examples, machine learning algorithm may be a gradient boosted tree and the model may be one or more data structures that describe the resultant nodes, leaves, edges, and the like of the tree.

In the prediction module 320, prediction feature data 390 may be input to the feature determination module 395. The prediction feature data 390 may include the data described above for the training feature data, but for a specific items such as dishwasher or dishware status identification or classification. In some examples, the prediction module 320 may be run sequentially for one or more items. Feature determination module 395 may operate the same, or differently than feature determination module 350. In some examples, feature determination modules 350 and 395 are the same modules or different instances of the same module. Feature determination module 395 produces vector 397, which is input into the model 120 to produce predictions 399. For example, the weightings and/or network structure learned by the training module 310 may be executed on the vector 397 by applying vector 397 to a first layer of the model 120 to produce inputs to a second layer of the model 120, and so on until the prediction 399 is output. As previously noted, other data structures may be used other than a vector (e.g., a matrix).

The training module 310 may operate in an offline manner to train the model 120. The prediction module 320, however, may be designed to operate in an online manner. It should be noted that the model 120 may be periodically updated via additional training and/or user feedback. For example, additional training feature data 330 may be collected. The feedback, along with the prediction feature data 390 corresponding to that feedback, may be used to refine the model by the training module 310.

In some example embodiments, results obtained by the model 120 during operation (e.g., outputs produced by the model in response to inputs) are used to improve the training data, which is then used to generate a newer version of the model. Thus, a feedback loop is formed to use the results obtained by the model to improve the model.

The machine learning algorithm 370 may be selected from among many different potential supervised or unsupervised machine learning algorithms. Examples of learning algorithms include artificial neural networks, convolutional neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, gradient boosted tree, linear classifiers, quadratic classifiers, k-nearest neighbor, linear regression, logistic regression, a region based CNN, a full CNN (for semantic segmentation), a mask R-CNN algorithm for instance segmentation, and hidden Markov models. Examples of unsupervised learning algorithms include expectation-maximization algorithms, vector quantization, and information bottleneck method.

The machine learning may include a machine learning model including a neural network. The machine learning model may include one or more of a long short-term memory (LSTM) network, bidirectional encoder representations from transformers (BERT), natural language processing (NLP), or an artificial intelligence (AI)-based knowledge tree, in various examples. In various examples, the artificial intelligence includes a large language model (LLM). Other types of machine learning models may be used without departing from the scope of the present subject matter.

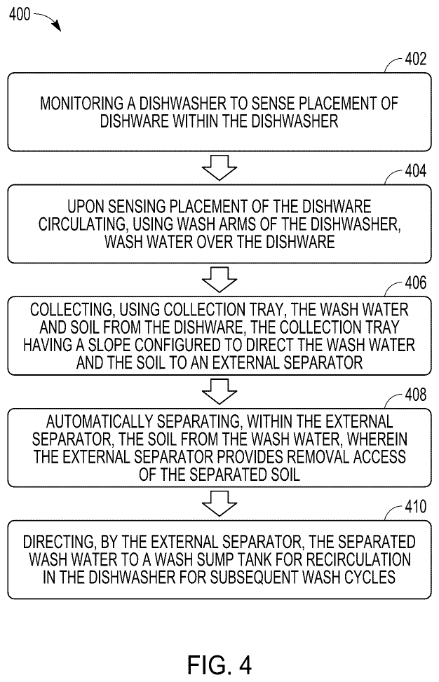

FIG. 4 illustrates a flowchart of a method for automatic prescrapping for a dishwasher, according to various embodiments. The method 400 includes monitoring a dishwasher to sense placement of dishware within the dishwasher, at step 402. Upon sensing placement of the dishware (and which may be before starting a wash cycle of the dishwasher), the method includes circulating, using wash arms of the dishwasher, wash water over the dishware, at step 404. Using a collection tray, the wash water and soil are collected from the dishware, at step 406. The collection tray includes a slope configured to direct the wash water and the soil to an external separator, in various examples. At step 408, the method further includes automatically separating, within the external separator, the soil from the wash water. The external separator provides removal access of the separated soil, in various embodiments. At step 410, the method also includes directing, by the external separator, the separated wash water to a wash sump tank for recirculation in the dishwasher for subsequent wash cycles.

According to various embodiments, monitoring the dishwasher includes using one or more sensors within the dishwasher. In some embodiments, monitoring the dishwasher includes using one or more sensors external to the dishwasher. The method further includes using machine learning to monitor the dishwasher and to determine when to initiate circulation of the wash water over the dishware, in various embodiments. The machine learning can be performed using a processor internal to the dishwasher, using a processor external to the dishwasher, or using both processors internal and external to the dishwasher. In some examples, the machine learning is performed using a processor of a mobile device. In some examples, the machine learning is performed using a cloud-based processor. The separated soil is configured to be removed from the external separator using a manual process, in some embodiments. In some embodiments, the separated soil is automatically discarded from the external separator.

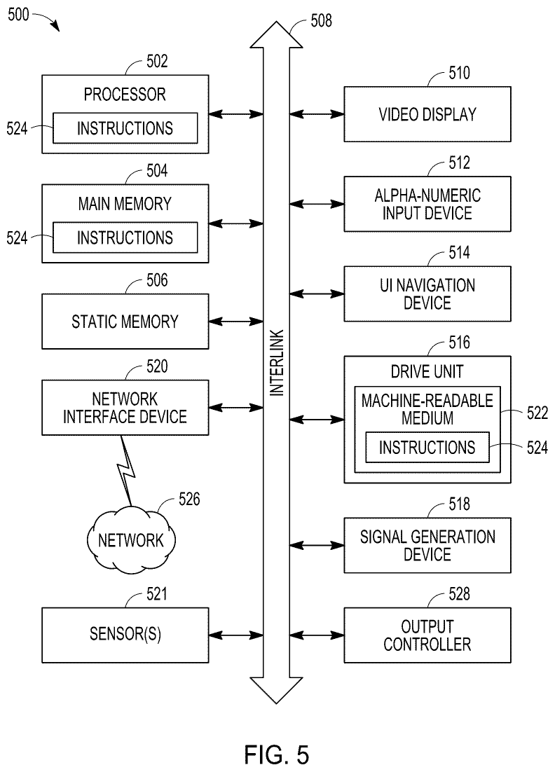

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be configured to perform the method of FIG. 4. The machine 500 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The processor 502 may be a digital signal processor (DSP), microprocessor, microcontroller, application-specific integrated circuit (ASIC), field-programmable gate array (FPGA), combinational logic, other digital logic, or combinations thereof. The processing may be done by a single processor, or may be distributed over different devices. The processing of signals referenced in this application may be performed using the processor or over different devices. Processing may be done in the digital domain, the analog domain, or combinations thereof. Processing may be done using subband processing techniques. Processing may be done using frequency domain or time domain approaches. Some processing may involve both frequency and time domain aspects. For brevity, in some examples, drawings may omit certain blocks that perform frequency synthesis, frequency analysis, analog-to-digital conversion, digital-to-analog conversion, signal transmission, amplification, buffering, and certain types of filtering and processing. In various examples of the present subject matter the processor is adapted to perform instructions stored in one or more memories, which may or may not be explicitly shown. Various types of memory may be used, including volatile and nonvolatile forms of memory. In various examples, the processor or other processing devices execute instructions to perform a number of processing tasks. In various examples of the present subject matter, different realizations of the block diagrams, circuits, and processes set forth herein may be created by one of skill in the art without departing from the scope of the present subject matter.

Machine (e.g., computer system) 500 may include a hardware processor 502 (e.g., a central processing unit (CPU), a graphics processing unit (GPU), a hardware processor core, or any combination thereof), a controller, a microcontroller, a microprocessor, a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 524 may further be transmitted or received over a communications network 526 using a transmission medium via the network interface device 520. The Machine 500 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include wired and wireless communications, such as Ethernet, Bluetooth, Bluetooth Low Energy, other Personal Area Networks (PANs), LoRa, NFC, Wi-Fi, WiMAX, 3G, 4G, LTE, 5G, the unlicensed 915 MHz Industrial, Scientific, and Medical (ISM) frequency band, ZigBee, among others. Some standards may support mesh networks. The networks include, but are not limited to, a local area network (LAN), a low-power wide-area network (LPWAN), a wide area network (WAN), a packet data network (e.g., the Internet), mobile telephone networks (e.g., cellular networks), Plain Old Telephone (POTS) networks, and wireless data networks, e.g., Institute of Electrical and Electronics Engineers (IEEE) 802.11 family of standards known as Wi-Fi®, IEEE 802.16 family of standards known as WiMax®, NFC, IEEE 802.15.4 family of standards, a Long Term Evolution (LTE) family of standards, a Universal Mobile Telecommunications System (UMTS) family of standards, peer-to-peer (P2P) networks, among others. The NFC circuitry may be embodied as relatively short-range, high frequency wireless communication circuitry and may implement standards such as ECMA-340/ISO/IEC 18092 and/or ECMA-352/ISO/IEC 21481 to communicate with other devices. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques.

### Other Notes and Examples

Example 1 is a method, including: monitoring a dishwasher to sense placement of dishware within the dishwasher; after sensing placement of the dishware, using wash arms of the dishwasher, circulating wash water over the dishware; collecting, using a collection tray, the wash water and soil from the dishware, the collection tray having a slope configured to direct the wash water and the soil to an external separator; automatically separating, within the external separator, the soil from the wash water, wherein the external separator provides removal access of the separated soil; and directing, by the external separator, the separated wash water to a wash sump tank for recirculation in the dishwasher for subsequent wash cycles.

Example 2 is the method of Example 1, wherein monitoring the dishwasher includes using one or more sensors within the dishwasher.

Example 3 is the method of Example 1, wherein monitoring the dishwasher includes using one or more sensors external to the dishwasher.

Example 4 is the method of Example 1, further including using machine learning to monitor the dishwasher and to determine when to initiate circulation of the wash water over the dishware.

Example 5 is the method of Example 4, wherein the machine learning is performed using a processor internal to the dishwasher.

Example 6 is the method of Example 4, wherein the machine learning is performed using a processor external to the dishwasher.

Example 7 is the method of Example 6, wherein the machine learning is performed using a processor of a mobile device.

Example 8 is the method of Example 6, wherein the machine learning is performed using a cloud-based processor.

Example 9 is the method of Example 1, wherein the separated soil is configured to be removed from the external separator using a manual process.

Example 10 is the method of Example 1, wherein the separated soil is automatically discarded from the external separator.

Example 11 is a system, including: one or more sensors configured to monitor a dishwasher to sense placement of dishware within the dishwasher; one or more processors configured to receive a signal from the one or more sensors, and further configured to initiate circulation of wash water over the dishware based on the signal; a collection tray configured to collect the wash water and soil from the dishware; and a separator configured to separate the soil from the wash water and provide removal access to the separated soil, wherein the collection tray includes a slope configured to direct the wash water and the soil to the separator, and wherein the separator is external to the dishwasher and is further configured to direct the separated wash water to a wash sump tank for recirculation into the dishwasher for subsequent wash cycles.

Example 12 is the system of Example 11, further including a housing configured to attach to a dishwasher.

Example 13 is the system of Example 12, wherein the separator is configured to be contained within the housing.

Example 14 is the system of Example 11, wherein the one or more processors are configured to use machine learning to determine when to initiate circulation of the wash water over the dishware.

Example 15 is the system of Example 11, wherein the one or more processors include a processor internal to the dishwasher.

Example 16 is the system of Example 11, wherein the one or more processors include a processor external to the dishwasher.

Example 17 is the system of Example 16, wherein the one or more processors include a processor of a mobile device.

Example 18 is the system of Example 16, wherein the one or more processors include a cloud-based processor.

Example 19 is the system of Example 11, further including a wireless communication circuit configured to send and receive data to and from the one or more processors.

Example 20 is the system of Example 11, further including a removable strainer within the separator, the removable strainer configured to separate the soil from the wash water.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The foregoing examples are not intended to be an exhaustive or exclusive list of examples and variations of the present subject matter. The above description is intended to be illustrative, and not restrictive. Those of skill in the art will appreciate additional variations of the embodiments that can be used within the scope of the teachings set forth herein. The scope of the invention should be determined with reference to the appended claims, along with the full scope of equivalents to which such claims are entitled.

What is claimed is:

1. A method, comprising:
monitoring a dishwasher to sense placement of dishware within the dishwasher;
after sensing placement of the dishware, using wash arms of the dishwasher, circulating wash water over the dishware;
collecting, using a collection tray, the wash water and soil from the dishware, the collection tray having a slope configured to direct the wash water and the soil to an external separator;
automatically separating, within the external separator, the soil from the wash water, wherein the external separator provides removal access of the separated soil; and
directing, by the external separator, the separated wash water to a wash sump tank for recirculation in the dishwasher for subsequent wash cycles.

2. The method of claim 1, wherein monitoring the dishwasher includes using one or more sensors within the dishwasher.

3. The method of claim 1, wherein monitoring the dishwasher includes using one or more sensors external to the dishwasher.

4. The method of claim 1, further comprising using machine learning to monitor the dishwasher and to determine when to initiate circulation of the wash water over the dishware.

5. The method of claim 4, wherein the machine learning is performed using a processor internal to the dishwasher.

6. The method of claim 4, wherein the machine learning is performed using a processor external to the dishwasher.

7. The method of claim 6, wherein the machine learning is performed using a processor of a mobile device.

8. The method of claim 6, wherein the machine learning is performed using a cloud-based processor.

9. The method of claim 1, wherein the separated soil is configured to be removed from the external separator using a manual process.

10. The method of claim 1, wherein the separated soil is automatically discarded from the external separator.

11. A system, comprising:
one or more sensors configured to monitor a dishwasher to sense placement of dishware within the dishwasher;
one or more processors configured to receive a signal from the one or more sensors, and further configured to initiate circulation of wash water over the dishware based on the signal;
a collection tray configured to collect the wash water and soil from the dishware; and
a separator configured to separate the soil from the wash water and provide removal access to the separated soil,
wherein the collection tray includes a slope configured to direct the wash water and the soil to the separator, and
wherein the separator is external to the dishwasher and is further configured to direct the separated wash water to a wash sump tank for recirculation into the dishwasher for subsequent wash cycles.

12. The system of claim 11, further comprising a housing configured to attach to a dishwasher.

13. The system of claim 12, wherein the separator is configured to be contained within the housing.

14. The system of claim 11, wherein the one or more processors are configured to use machine learning to determine when to initiate circulation of the wash water over the dishware.

15. The system of claim 11, wherein the one or more processors include a processor internal to the dishwasher.

16. The system of claim 11, wherein the one or more processors include a processor external to the dishwasher.

17. The system of claim 16, wherein the one or more processors include a processor of a mobile device.

18. The system of claim 16, wherein the one or more processors include a cloud-based processor.

19. The system of claim 11, further comprising a wireless communication circuit configured to send and receive data to and from the one or more processors.

20. The system of claim 11, further comprising a removable strainer within the separator, the removable strainer configured to separate the soil from the wash water.
